(19) United States
(12) Patent Application Publication
(10) Pub. No.: US 2010/0330404 A1
(43) Pub. Date: Dec. 30, 2010

(54) BATTERY HOUSING TRAY AND ASSEMBLED-BATTERY HOUSING TRAY USING THE SAME

(75) Inventors: Hajime Nishino, Osaka (JP); Mikinari Shimada, Osaka (JP); Shinji Kasamatsu, Osaka (JP); Yasushi Hirakawa, Osaka (JP); Tomohiko Yokoyama, Osaka (JP)

Correspondence Address: Brinks Hofer Gilson & Lione/Panasonic, P.O. Box 10395, Chicago, IL, 60610, US

(73) Assignee: Panasonic Corporation, Kadoma-shi, Osaka (JP)

(21) Appl. No.: 12/866,682

(22) PCT Filed: Feb. 9, 2009
(86) PCT No.: PCT/JP2009/000494

§ 371 Date: Aug. 6, 2010

(30) Foreign Application Priority Data
Feb. 12, 2008 (JP) 2008-030255
Feb. 12, 2008 (JP) 2008-030256

(51) Int. Cl. H01M 2/12

(52) U.S. Cl. 429/82

(57) ABSTRACT

A PTC resistor according to the present invention comprises at least one PTC composition which comprises at least one resin and at least two conductive materials. The at least two conductive materials comprises at least two conductive materials different from each other. The at least one PTC composition may comprise a first PTC composition which comprises a first resin and at least one first conductive material and a second PTC composition which is compounded with the first PTC composition and comprises a second resin and at least one second conductive material. The at least one first conductive material is at least partially different from the at least one second conductive material. One of the first resin and the second resin may comprise a reactant resin and a reactive resin which is cross-linked with the reactant resin. The PTC resistor may comprise a flame retardant agent. The PTC resistor may comprise a liquid-resistant resin.

### RELATED APPLICATIONS

This application is a 371 application of PCT/JP2009/000494 having an international filing date of Feb. 9, 2009, which claims priority to JP2008-030255 filed on Feb. 12, 2008 and JP2008-030256 filed on Feb. 12, 2008, the entire contents of which are incorporated herein by reference.

### TECHNICAL FIELD

The present invention relates to a battery housing tray capable of safely housing a plurality of batteries in which, even if faults such as heat generation occur in a battery due to trouble in manufacturing facilities and the like during a manufacturing process of batteries, the faults do not affect other batteries, and to an assembled battery housing tray using the battery housing tray.

### BACKGROUND ART

Recently, from the viewpoint of resource savings and energy savings, demands for secondary batteries employing nickel hydrogen, nickel cadmium or lithium ions, which can be used repeatedly, are increased. Among them, the lithium ion secondary battery has a high electromotive force and a large energy density although it has light weight. Therefore, the demand for the lithium ion secondary battery is expanded as a driving power source for various types of portable electronic apparatuses and mobile telecommunication apparatuses, for example, portable telephones, digital cameras, video cameras, and notebook-sized personal computers, and the like.

Generally, in a manufacturing process of secondary batteries, after batteries are assembled in the form of a battery itself, various treatment processes to obtain battery property are carried out, and then the batteries are commercialized. At that time, the treatment processes such as an initial charging and discharging process, an aging process, and a pre-shipment charging and discharging process are carried out. Thus, the presence or absence of a minor internal short circuit in a battery or functions of components constituting a battery are inspected, and a secondary battery having high performance and high reliability is provided. Such treatment processes are carried out in a state in which a plurality of batteries are housed in a tray in consideration of productivity.

However, in the above-mentioned treatment processes, an internal short circuit may occur in a battery, or an abnormal voltage may be applied to a battery because of a fault in a charging and discharging tester, and the like. In this case, in such batteries, abnormal heat generation or gas release due to rapid increase in the internal pressure of the battery can occur. At such a time, a safety mechanism provided in the battery cannot sufficiently work, and explosion or ignition may occur on rare occasion.

An example is disclosed in which batteries housed in a tray are monitored by an infrared ray monitor, a battery with abnormal heat generation is discriminated and eliminated in a charging and discharging process (see, for example, Patent Document 1).

Furthermore, an example is disclosed in which abnormality is detected by an odor sensor, a temperature sensor, and the like, and an inert gas or a fire-extinguishing agent is ejected to a whole device including a tray, thus preventing ignition or explosion of a battery from spreading, when a fault occurs in a battery housed in the tray in a charging and discharging process or an aging process (see, for example, Patent Documents 2 and 3).

In a temperature measurement device described in Patent Document 1, when heat generation occurs in a secondary battery housed in a tray, a battery with heat generation can be eliminated so as to prevent the influence on other batteries. However, Patent Document 1 does not describe a mechanism for preventing the influence on other batteries when a battery is abnormally heated and ignition or explosion occurs.

Furthermore, in Patent Documents 2 and 3, when a battery with a fault causes ignition or explosion in a battery depository or chamber space for carrying out a charging and discharging test, a fire-extinguishing agent is filled in the battery depository or the chamber space so as to extinguish the fire. Therefore, normal batteries existing in the battery depository or the chamber space are required to be disposed of or subjected to regenerating process when they are not disposed of. Furthermore, there is a problem that all charging and discharging devices in the battery depository or the chamber space become unusable. Furthermore, since the fire may be beyond the extinguishing ability of the facilities when the fire spreads, it is necessary to extinguish the fire while the fire is small.
Patent Document 1: Japanese Patent Unexamined Publication No. H10-281881
Patent Document 2: Japanese Patent Unexamined Publication No. H11-169475
Patent Document 3: Japanese Patent Unexamined Publication No. 2003-190312

### SUMMARY OF THE INVENTION

A battery housing tray of the present invention houses a plurality of batteries each having a vent mechanism. The battery housing tray includes a housing member having an outer peripheral frame with a height exceeding a height of each of a plurality of batteries, and a bottom part; a barrier rib member configured to individually house the batteries in the housing member; and an opening opposite the bottom part. In the configuration, a height of the barrier rib member is more than 50% of the height of each of the batteries and less than the height of the outer peripheral frame of the housing member, and the batteries are housed in a manner that a vent mechanism side of each of the batteries faces the opening.

With such a configuration, it is possible to achieve a battery housing tray that is excellent in safety in which a flame produced by ignition of gas ejected from a vent hole of one of the batteries with a fault is dispersed in space above the barrier rib member, thus preventing the flame from spreading to the surrounding batteries or abnormally overheating in advance.

Furthermore, an assembled battery housing tray of the present invention has a configuration in which the above-mentioned battery housing trays are stacked. Thus, it is possible to achieve an assembled battery housing tray with safety and high reliability in which even when a plurality of battery housing trays are stacked in multiple stages, fire is less likely to spread.

### BRIEF DESCRIPTION OF THE DRAWINGS

FIG. 1 is a cross-sectional view of a battery housed in a battery housing tray in accordance with a first exemplary embodiment of the present invention.

FIG. 2A is a perspective view of the battery housing tray in accordance with the first exemplary embodiment of the present invention.

FIG. 2B is a sectional view taken along line 2B-2B of FIG. 2A.

FIG. 3A is a perspective view of another example of a battery housing tray in accordance with the first exemplary embodiment of the present invention.

FIG. 3B is a sectional view taken along line 3B-3B of FIG. 3A.

FIG. 4A is a perspective view of a battery housing tray in accordance with a second exemplary embodiment of the present invention.

FIG. 4B is a sectional view taken along line 4B-4B of FIG. 4A.

FIG. 5A is a plan view of a battery housing tray seen from the upper part in accordance with a third exemplary embodiment of the present invention.

FIG. 5B is a sectional view taken along line 5B-5B of FIG. 5A.

FIG. 6 is a sectional view to illustrate an assembled battery housing tray in accordance with a fourth exemplary embodiment of the present invention.

FIG. 7A is a sectional view showing another example of an assembled battery housing tray before battery housing trays are stacked in accordance with the fourth exemplary embodiment of the present invention.

FIG. 7B is a sectional view showing another example of an assembled battery housing tray after battery housing trays are stacked in accordance with the fourth exemplary embodiment of the present invention.

FIG. 8A is a transparent plan view of an assembled battery housing tray seen from the upper part in accordance with a fifth exemplary embodiment of the present invention.

FIG. 8B is a sectional view taken along line 8B-8B of FIG. 8A.

FIG. 9A is a perspective view of a battery housing tray in accordance with a sixth exemplary embodiment of the present invention.

FIG. 9B is a sectional view taken along line 9B-9B of FIG. 9A.

FIG. 10A is a perspective view of another example of a battery housing tray in accordance with the sixth exemplary embodiment of the present invention.

FIG. 10B is a sectional view taken along line 10B-10B of FIG. 10A.

FIG. 11A is a perspective view of a battery housing tray in accordance with a seventh exemplary embodiment of the present invention.

FIG. 11B is a sectional view taken along line 11B-11B of FIG. 11A.

FIG. 12A is a plan view of a battery housing tray seen from the upper part in accordance with an eighth exemplary embodiment of the present invention.

FIG. 12B is a sectional view taken along line 12B-12B of FIG. 12A.

FIG. 13A is a sectional view showing an assembled battery housing tray before battery housing trays are stacked in accordance with a ninth exemplary embodiment of the present invention.

FIG. 13B is a sectional view showing an assembled battery housing tray after battery housing trays are stacked in accordance with the ninth exemplary embodiment of the present invention.

FIG. 14A is a sectional view showing another example 1 of an assembled battery housing tray before battery housing trays are stacked in accordance with the ninth exemplary embodiment of the present invention.

FIG. 14B is a sectional view showing another example 1 of an assembled battery housing tray after battery housing trays are stacked in accordance with the ninth exemplary embodiment of the present invention.

FIG. 15 is a sectional view showing another example 2 of an assembled battery housing tray in accordance with the ninth exemplary embodiment of the present invention.

FIG. 16A is a sectional view showing another example 1 of a first barrier rib member and a second barrier rib member of the battery housing tray in accordance with the ninth exemplary embodiment of the present invention.

FIG. 16B is a sectional view showing another example 2 of a first barrier rib member and a second barrier rib member of the battery housing tray in accordance with the ninth exemplary embodiment of the present invention.

FIG. 17A is a transparent plan view of an assembled battery housing tray seen from the upper part in accordance with a tenth exemplary embodiment of the present invention.

FIG. 17B is a sectional view taken along line 17B-17B of FIG. 17A.

FIG. 18A is a sectional view to illustrate a form of air holes applied in the exemplary embodiments of the present invention.

FIG. 18B is a sectional view to illustrate a form of air holes applied in the exemplary embodiments of the present invention.

FIG. 18C is a sectional view to illustrate a form of air holes applied in the exemplary embodiments of the present invention.

### DETAILED DESCRIPTION OF THE PREFERRED EMBODIMENT

Hereinafter, exemplary embodiments of the present invention are described with reference to drawings in which the same reference numerals are given to the same components. Note here that the present invention is not limited to the embodiments mentioned below as long as it is based on the basic features described in the description. Furthermore, in the below description, a non-aqueous electrolyte secondary battery (hereinafter, referred to as a “battery”) such as a lithium ion battery is described as an example of a battery. Needless to say, however, the battery is not necessarily limited to this example.

### First Exemplary Embodiment

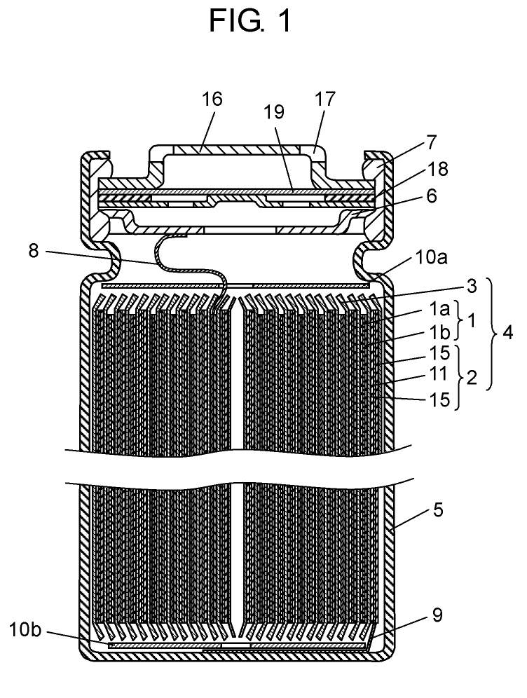

FIG. 1 is a cross-sectional view showing a battery housed in a battery housing tray in accordance with a first exemplary embodiment of the present invention.

As shown in FIG. 1, a cylindrical battery has electrode group 4 in which positive electrode 1 provided with positive electrode lead 8 made of, for example, aluminum, and negative electrode 2 facing positive electrode 1 and provided with negative electrode lead 9 made of, for example, copper at one end are wound together with separator 3 interposed between positive electrode 1 and negative electrode 2. Then, insulating plates 10a and 10b are mounted on the upper and lower parts of electrode group 4, which are inserted into battery case 5. The other end of positive electrode lead 8 is welded to sealing plate 6 and the other end of negative electrode lead 9 is welded on the bottom part of battery case 5. Furthermore, a non-aqueous electrolyte (not shown) conducting lithium ion is injected into battery case 5. Then, an open end of battery case 5 is caulked with respect to positive electrode cap 16, current blocking member 18 such as a PTC element, and sealing plate 6 via gasket 7. Furthermore, positive electrode cap 16 is provided with vent hole 17 for extracting a gas generated when vent mechanism 19 is opened due to a fault in electrode group 4. Positive electrode 1 includes positive current collector 1a and positive electrode layer 1b containing a positive electrode active material.

Herein, positive electrode layer 1b includes a lithium-containing composite oxide such as LiCoO₂, LiNiO₂, and Li₂MnO₄ or a mixture thereof or a composite compound thereof, as a positive electrode active material. Positive electrode layer 1b further includes a conductive agent and a binder. An example of the conductive agent may include graphites such as natural graphites and artificial graphites; and carbon blacks such as acetylene black, Ketjen black, channel black, furnace black, lampblack, thermal black, and the like. Furthermore, an example of the binder includes PVDF, polytetrafluoroethylene, polyethylene, polypropylene, aramid resin, polyamide, polyimide, and the like.

As positive current collector 1a used in positive electrode 1, aluminum (Al), carbon, conductive resin, and the like, can be used.

As the non-aqueous electrolyte, an electrolyte solution obtained by dissolving a solute in an organic solvent, or a so-called a polymer electrolyte layer including the electrolyte solution and immobilized by a polymer can be used. The solute of the nonaqueous electrolyte includes LiPF₆, LiBF₄, LiClO₄, LiAlCl₄, LiSbF₆, LiSCN, LiCF₃SO₃, LiN(CF₃CO₂), LiN(CF₃SO₂)₂, and the like. Furthermore, an example of the organic solvent may include ethylene carbonate (EC), propylene carbonate, butylene carbonate, vinylene carbonate, dimethyl carbonate (DMC), diethyl carbonate, ethyl methyl carbonate (EMC), and the like.

Furthermore, as negative current collector 11 for negative electrode 2, a metal foil of, for example, stainless steel, nickel, copper, and titanium, and a thin film of carbon and conductive resin are used.

Furthermore, for negative electrode layer 15 of negative electrode 2, carbon materials such as graphite, silicon (Si), tin (Sn), or the like, can be used as a negative electrode active material capable of reversibly absorbing and releasing lithium ions. Si, Sn, or the like has a theoretical capacity density of more than 833 mAh/cm³.

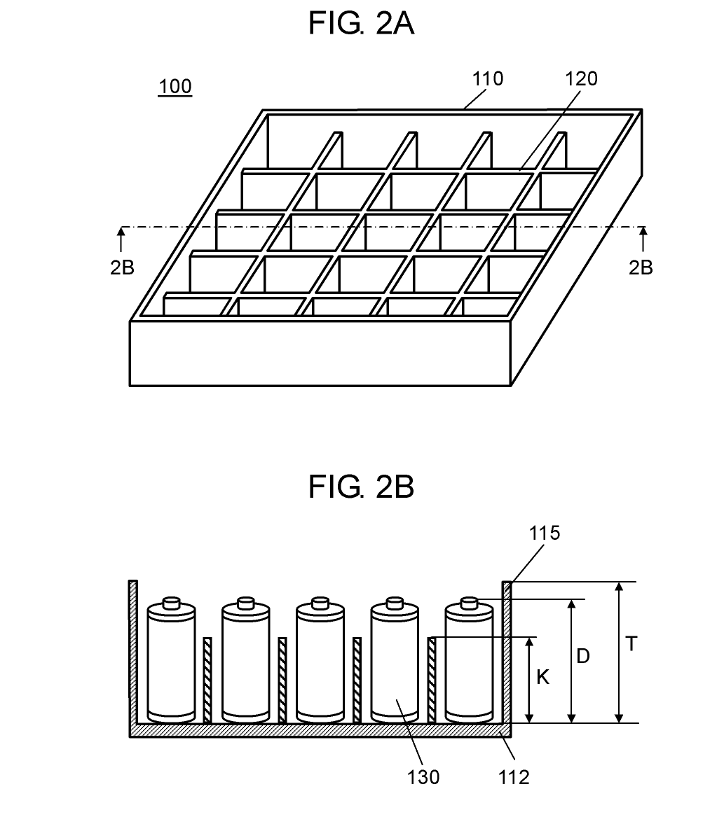

Hereinafter, a battery housing tray in accordance with the first exemplary embodiment of the present invention is described in detail with reference to FIGS. 2A and 2B.

FIG. 2A is a perspective view of a battery housing tray in accordance with the first exemplary embodiment of the present invention. FIG. 2B is a sectional view taken along line 2B-2B of FIG. 2A. For easy understanding, FIG. 2B shows a state in which cylindrical batteries shown in a perspective view are housed.

As shown in FIG. 2A, battery housing tray 100 includes housing member 110 having bottom part 112 made of an insulating resin material such as polypropylene resin, and barrier rib member 120 made of an insulating resin material such as polypropylene resin and incorporated in the inner peripheral side of housing member 110. In this case, housing member 110 and barrier rib member 120 are formed individually and separably from each other. An opening is provided opposite bottom part 112.

As shown in FIG. 2B, housing member 110 has outer peripheral frame 115 having height T exceeding height D (a length between a positive electrode cap and a bottom surface of a battery case) of battery 130 when predetermined battery 130 is housed. Furthermore, barrier rib member 120 individually houses a plurality of predetermined batteries 130 and has height K that is at least more than 50% of the height of battery 130. For example, when the height of a battery is 65 mm, the height of barrier rib member 120 is more than 32.5 mm.

That is to say, as shown in FIG. 2B, a plurality of batteries 130 are housed in battery housing tray 100 including barrier rib member 120 whose height exceeds 50% of the height of battery 130 and outer peripheral frame 115 whose height exceeds the height of battery 130.

Note here that the present invention is based on the findings that when the height of barrier rib member 120 is not more than 50% of the height of battery 130, ignition or explosion of a faulty battery may cause spread of fire to batteries in the surroundings. Furthermore, when a plurality of battery housing trays are used in a stacked state, ignition or energy of explosion of the battery is released into space formed by a barrier rib member and an outer peripheral frame thanks to the height of outer peripheral frame 115 of housing member 110 being made to be a height exceeding the height of battery. Thereby, accumulated heat is released, so that ignition or smoking in the surrounding batteries can be prevented.

At this time, it is preferable that the height of barrier rib member 120 is not less than 80% of the height of battery 130. This is preferable because a heat insulation effect by the barrier rib member can be enhanced.

Herein, the above-mentioned exemplary embodiment describes an example in which the materials of the housing member and the barrier rib member are polypropylene resin, but the material is not necessarily limited to this example. For example, phenol resin, UNILATE, glass epoxy resin, ceramic, and foaming resin may be used. At this time, it is preferable that the above-mentioned resin contains filler such as carbon fiber and glass fiber. The filler to be contained can prevent the strength of the housing member and the barrier rib member from deteriorating and can maintain the shapes thereof under high temperatures generated at the time of heat generation or ignition of a faulty battery. That is to say, when the shapes cannot be maintained, the faulty battery tends to fall toward the surrounding batteries. Thus, it is possible to reduce the influence of ignition or heat generation on the surrounding batteries and reduce the possibility of spread of fire. Furthermore, heat absorbing agent such as magnesium hydroxide (Mg(OH)₂) may be added in the above-mentioned resin. Thus, by transferring heat to the battier rib member in the surroundings, it is possible to suppress temperature rise in the battier rib member around a faulty battery. Furthermore, by suppressing the temperature rise, it is possible to enhance the effect of preventing the strength from deteriorating and maintaining the shape in the barrier rib member and the like.

Alternatively, the housing member and the barrier rib member may have a configuration in which metal materials such as copper (Cu), aluminum (Al) and iron (Fe) are coated with the above-mentioned insulating resin. Thus, high heat transfer property can be achieved and the mechanical strength can be enhanced. When a short circuit due to contact with battery does not occur, the housing member and the barrier rib member may be formed of only metal materials. Furthermore, the metal material may have a mesh structure or a structure having a plurality of through holes. Thus, while the heat transfer property or mechanical strength can be maintained, the weight of the housing member and the barrier rib member can be reduced.

According to this exemplary embodiment, a flame occurring at the time of ignition or explosion of gas ejected from a vent hole of a faulty battery can be dispersed into space above the barrier rib member, thus preventing spread of fire to the surrounding batteries or abnormal overheating. Furthermore, by setting the height of the barrier rib member to a predetermined height, heating of an electrode group inside a battery case of the battery can be considerably suppressed, spread of fire, and the like, can be prevented.

Furthermore, with a structure in which the housing member and the barrier rib member are formed individually and separably from each other, only by preparing a barrier rib member corresponding to the shape of a battery, various types of batteries can be housed in the same housing member. As a result, it is possible to achieve a battery housing tray with high versatility capable of stacking batteries having different shapes in multiple stages.

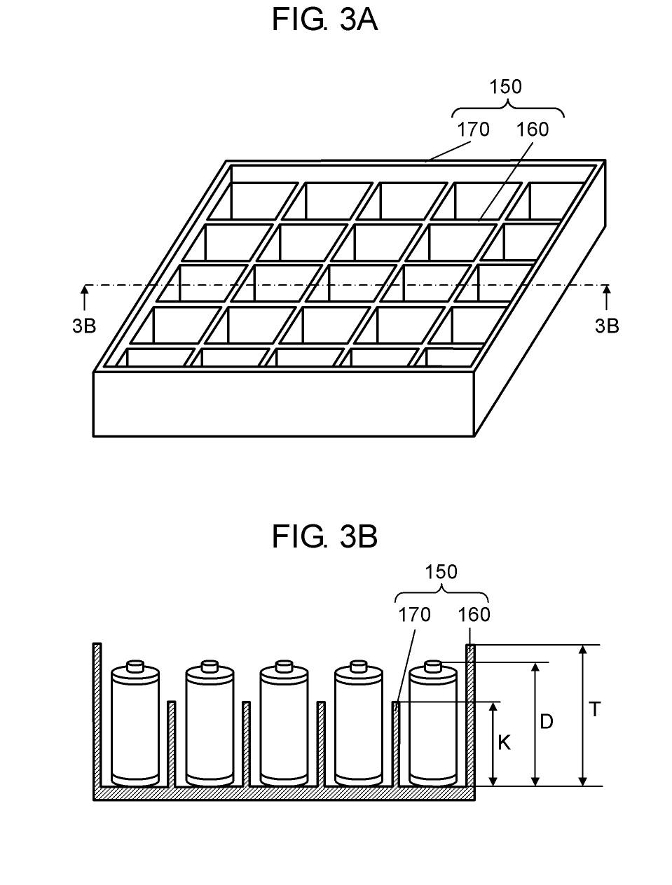

The above-mentioned exemplary embodiment describes an example in which the housing member and the barrier rib member are formed individually and separably from each other, but a structure is not necessarily limited to this. For example, as shown in FIG. 3A that is a perspective view of another example of a battery housing tray in accordance with the first exemplary embodiment of the present invention and FIG. 3B that is a sectional view taken along line 3B-3B of FIG. 3A, battery housing tray 150 in which housing member 160 and barrier rib member 170 are integrated with each other may be employed. Thus, the deterioration of the mechanical strength of a barrier rib member can be suppressed, and heat transfer efficiency can be enhanced by the increases in the heat releasing area. Thus, a battery housing tray with higher safety can be achieved.

### Second Exemplary Embodiment

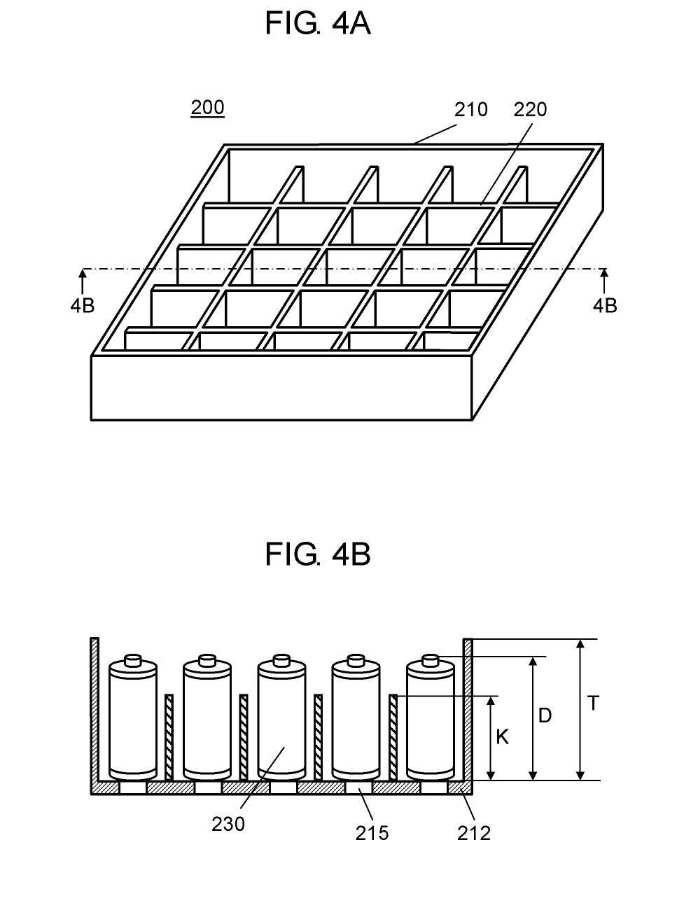

FIG. 4A is a perspective view of a battery housing tray in accordance with a second exemplary embodiment of the present invention. FIG. 4B is a sectional view taken along line 4B-4B of FIG. 4A. This exemplary embodiment also describes an example in which cylindrical batteries similar to those in FIG. 1 are housed.

This exemplary embodiment has the same configuration as that in the first exemplary embodiment except that through holes are provided in a bottom part of a housing member.

Similar to the first exemplary embodiment, as shown in FIG. 4A, battery housing tray 200 includes housing member 210 having a bottom part and being made of an insulating resin material such as polypropylene resin, and barrier rib member 220 made of an insulating resin material such as polypropylene resin and incorporated in the inner peripheral side of housing member 210. In this case, housing member 210 and barrier rib member 220 are formed individually and separably from each other.

As shown in FIG. 4B, through holes 215 smaller than the outer diameter of battery 230 are provided in bottom part 212 of housing member 210, in a region surrounded by barrier rib member 220.

According to this exemplary embodiment, battery housing tray 200 that houses batteries 230 is disposed in a charging and discharging tester. Thereby, the plus of a positive electrode cap of the battery and the minus on the bottom part of the battery case are connected to the tester via through hole 215 in housing member 210 so as to evaluate the battery. Thus, during a charging and discharging test, even if ignition or explosion of a faulty battery, and furthermore, explosion or ignition caused by an abnormal voltage or electric current due to a fault of the tester occur, it is possible to prevent fire from spreading to the surrounding batteries.

At this time, it is more preferable that through hole 215 is smaller than the diameter of the top portion of the positive electrode cap of battery 230. This structure can prevent a flame and the like from directly parching a battery disposed immediately above, when a flame occurs at the time of structuring an assembled battery housing tray in which battery housing trays are stacked, and the flame is ejected in the oblique direction from the vent hole provided on the side surface of the positive electrode cap of the battery, which is described in detail in the following exemplary embodiment.

### Third Exemplary Embodiment

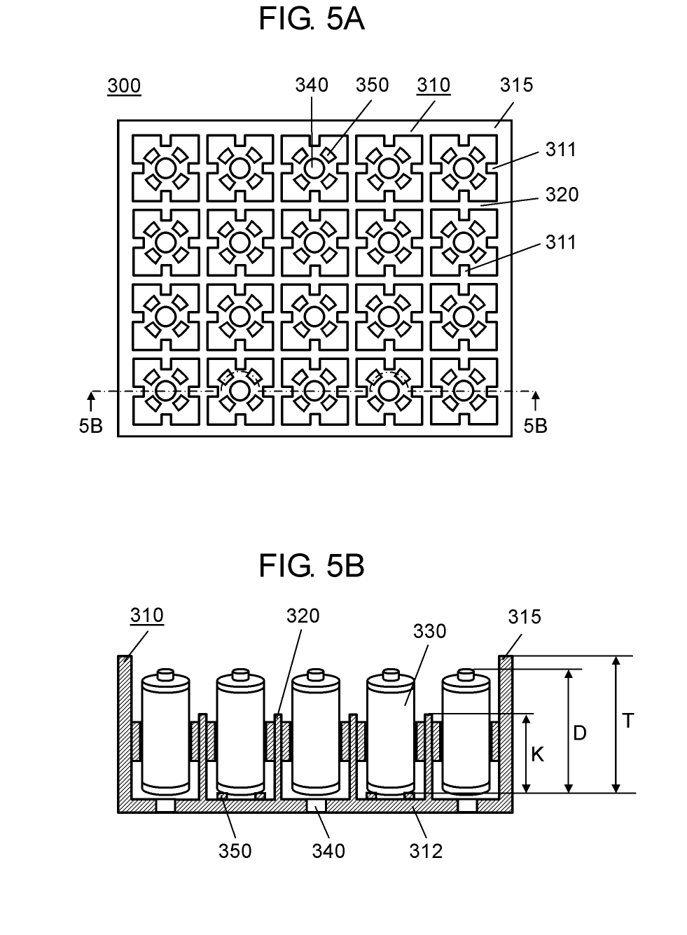

FIG. 5A is a plan view of a battery housing tray seen from the upper part in accordance with a third exemplary embodiment of the present invention. FIG. 5B is a sectional view taken along line 5B-5B of FIG. 5A. This exemplary embodiment also describes an example in which cylindrical batteries similar to those in FIG. 1 are housed.

As shown in FIG. 5A, battery housing tray 300 includes housing member 310 having a bottom part made of an insulating resin material such as polypropylene resin, and barrier rib member 320 made of an insulating resin material such as polypropylene resin, which are integrated with each other. Furthermore, rib portions 311 are formed at the inner side of housing member 310 and the inner side of barrier rib member 320. In addition, on bottom part 312 of housing member 310 in a region surrounded by barrier rib member 320, through holes 340 smaller than an outer diameter of battery 330 and rib portions 350 partially holding the bottom part of battery 330 are provided.

As shown in FIG. 5B, housing member 310 has outer peripheral frame 315 having height T exceeding height D (a length between a positive electrode cap and a bottom surface of a battery case) of predetermined battery 330 when battery 330 is housed. Furthermore, barrier rib member 320 individually houses a plurality of predetermined batteries 330 and has a height that is more than 50% of the height of battery 330 from a contact surface between rib portion 350 on bottom part 312 of housing member 310 and battery 330. For example, when the height of the rib portion is 1 mm and the height of the battery is 65 mm, the height of barrier rib member 320 is more than 33.5 mm.

The configurations and materials of the above-mentioned housing member, the barrier rib member, the rib portion, and the like, are the same as those in the first exemplary embodiment and the description therefor is omitted herein.

According to this exemplary embodiment, similar to the first exemplary embodiment, a flame occurring at the time of ignition or explosion of gas ejected from a vent hole of a faulty battery can be dispersed into space above the barrier rib member, thus preventing spread of fire to the surrounding batteries and preventing abnormal overheating.

Furthermore, according to this exemplary embodiment, with the rib portions provided on the housing member and the barrier rib member, positioning of batteries to be housed can be carried out easily. Thus, the distance between the neighboring batteries can be kept uniform. Thus, the influence of heat generation or ignition of a faulty battery on the neighboring batteries can be made to be uniform. Therefore, the influence of heat generation and the like can be further suppressed as compared with the case in which rib portions are not provided.

Furthermore, according to the exemplary embodiment of the present invention, with the rib portions provided on the housing member and the barrier rib member, a circulation passage of air and the like is formed, so that a temperature around the batteries can be made to be uniform during, for example, an aging process.

The above-mentioned exemplary embodiment describes an example in which through holes are provided in the bottom part of the housing member, but through holes may not be provided when a charging and discharging test is not carried out. Furthermore, the exemplary embodiment describes an example in which rib portions are provided on the bottom part of the housing member, but these are not particularly necessary when only positioning of the battery is intended.

### Fourth Exemplary Embodiment

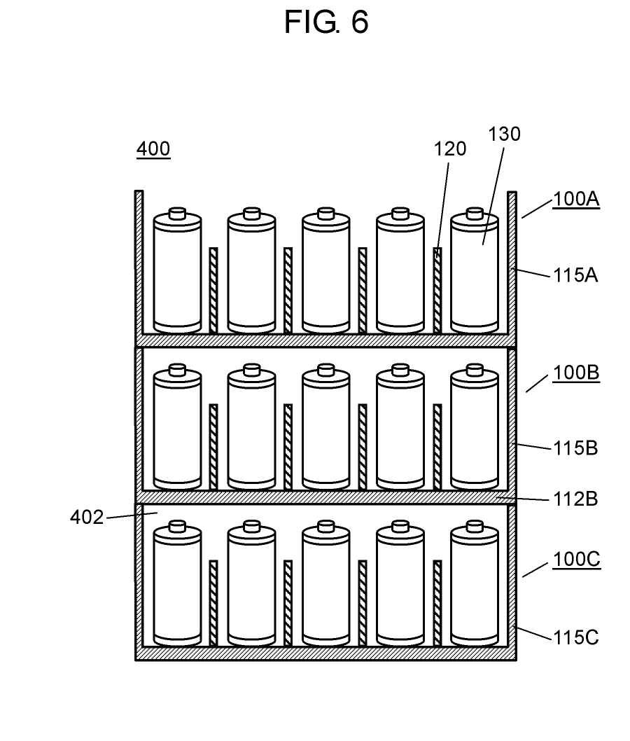

FIG. 6 is a sectional view to illustrate an assembled battery housing tray in accordance with a fourth exemplary embodiment of the present invention. This exemplary embodiment also describes an example in which cylindrical batteries similar to those in FIG. 1 are housed.

As shown in FIG. 6, assembled battery housing tray 400 in accordance with the fourth exemplary embodiment of the present invention has a configuration in which battery housing trays 100A, 100B, and 100C described in the first exemplary embodiment are stacked in, for example, three stages. Since the configurations of battery housing trays 100A, 100B, and 100C are the same as the configuration of the battery housing tray in the first exemplary embodiment, the description thereof is omitted.

That is to say, as shown in FIG. 6, a plurality of battery housing trays 100A, 100B, and 100C are stacked via outer peripheral frames 115A, 115B, and 115C of each battery housing tray.

Thus, space 402 is formed between, for example, bottom part 112B of battery housing tray 100B and outer peripheral frame 115C of battery housing tray 100C. As a result, energy generated when ignition or explosion of a faulty battery occurs can be dispersed to space 402. Thus, abnormal overheating or concentration of a flame on the surrounding batteries can be reduced, and an induced explosion or spread of fire can be prevented. The same is true to the relation between battery housing tray 100B and battery housing tray 100A. In addition, in battery housing tray 100A, since the upper part of battery 130 is opened, the influence on the surrounding batteries can be further reduced.

According to this exemplary embodiment, it is possible to achieve an assembled battery housing tray with high safety and high reliability in which the influence of heat generation or ignition of a faulty battery can be prevented even when a plurality of battery housing trays are stacked.

In the above mention, an example in which the battery housing trays of the first exemplary embodiment are stacked is described. However, the configuration is not necessarily limited to this example, and the battery housing trays of the second or third exemplary embodiment may be stacked. In this case, the same effect can be also obtained.

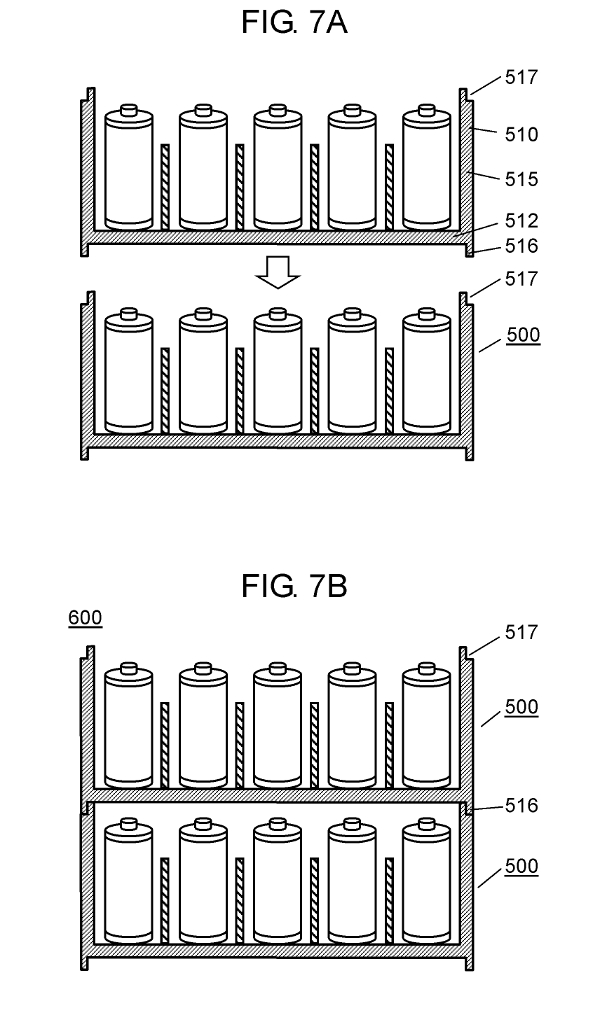

Hereinafter, another example of an assembled battery housing tray in accordance with the fourth exemplary embodiment is described with reference to FIGS. 7A and 7B.

FIGS. 7A and 7B are sectional views to illustrate another example of an assembled battery housing tray in accordance with the fourth exemplary embodiment of the present invention. FIG. 7A is a sectional view showing a state before battery housing trays are stacked, and FIG. 7B is a sectional view showing a state after battery housing trays are stacked.

That is to say, as shown in FIG. 7A, battery housing tray 500 includes first concave portion 517 at the end surface of outer peripheral frame 515 of housing member 510, and second convex portion 516 to be fitted with first concave portion 517 is provided on the outer surface of bottom part 512. Then, for example, by allowing first concave portion 517 of battery housing tray 500 on the lower stage to be fitted with second convex portion 516 of battery housing tray 500 on the upper stage, assembled battery housing tray 600 is formed.

Thus, it is possible to achieve an assembled battery housing tray that prevents displacement in the battery housing trays to be stacked and improves stability at the time of stacking.

In the above mention, an example in which a first concave portion is provided on the outer peripheral frame and a second convex portion is provided on the bottom part in the housing member is described. However, the configuration is not necessarily limited to this example. For example, a configuration in which a first convex portion is provided on the outer peripheral frame and a second concave portion is provided on the bottom part in the housing member may be employed. In this case, the same effect can be obtained.

In the above mention, an example in which a second convex portion is provided on the battery housing tray on the bottom stage is described, but it may not be particularly provided.

Furthermore, the above-mentioned exemplary embodiment describes a configuration in which an upper part of the battery housing tray on the top stage is opened, but the configuration is not necessarily limited to this example. For example, a lid is formed from the housing member from which the outer peripheral frame is removed and which includes bottom part and a second convex portion, and the battery housing tray on the top stage is lidded by the above-mentioned lid. Such a configuration may be acceptable. Thus, even if ignition or explosion occurs in a faulty battery on the battery housing tray on the top stage, scattering thereof can be securely prevented by the lid.

### Fifth Exemplary Embodiment

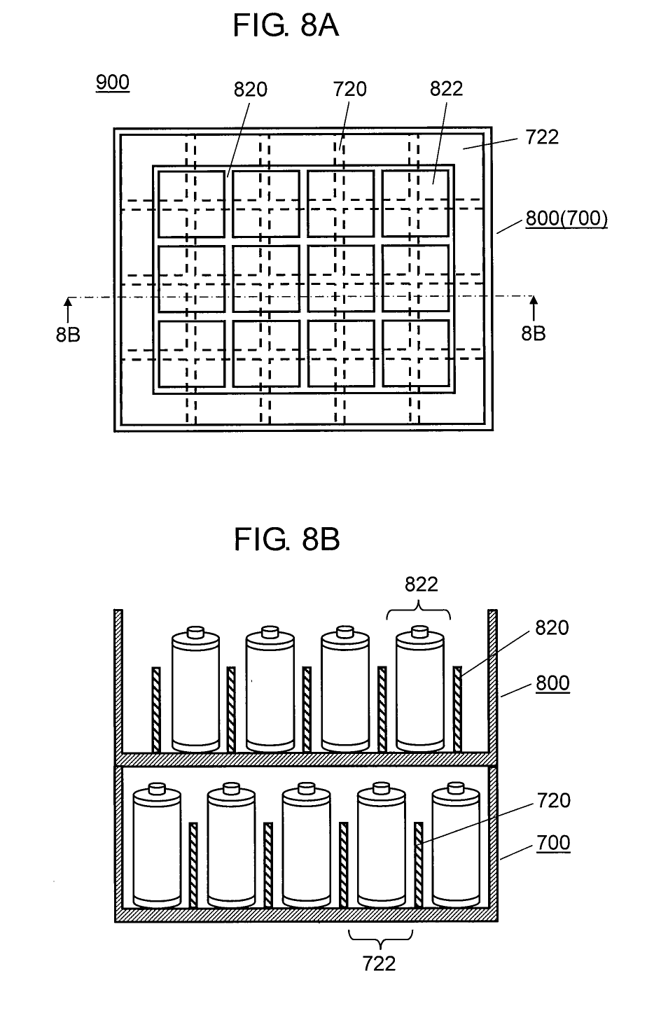

FIG. 8A is a transparent plan view of an assembled battery housing tray seen from the upper part in accordance with a fifth exemplary embodiment of the present invention. FIG. 8B is a sectional view taken along line 8B-8B of FIG. 8A. For easy understanding, FIG. 8B shows a state in which cylindrical batteries shown in a perspective view are housed.

As shown in FIG. 8B, this exemplary embodiment is different from the fourth exemplary embodiment in that batteries in a battery housing tray of the lower stage and batteries in a battery housing tray of the upper stage are shifted from each other in the stacked direction so that they are not immediately (directly) overlapped to each other. Hereinafter, an example in which the battery housing trays are stacked in two stages is described, but the configuration is not necessarily limited to this example.

That is to say, as shown in FIG. 8B, on the upper part of first battery housing tray 700 provided with barrier rib member 720, second battery housing tray 800 provided with barrier rib member 820 is stacked, thus forming assembled battery housing tray 900. At this time, as shown in FIG. 8A, battery housing region 722 surrounded by barrier rib member 720 (broken line in the drawing) and battery housing region 822 surrounded by barrier rib member 820 are disposed such that they are shifted from each other.

According to this exemplary embodiment, at the time of stacking, a battery to be stacked is not disposed immediately above another battery. Therefore, the length between the stacked batteries can be increased, and the influence of ignition or explosion caused by a gas ejected from a faulty battery can be further reduced.

Note here that, as shown in FIG. 8A, this exemplary embodiment describes an example in which battery housing region 822 defined by barrier rib member 820 of second battery housing tray 800 is disposed so as to span four battery housing regions 722 defined by barrier rib member 720 of first battery housing tray 700. However, the configuration is not necessarily limited to this example. For example, battery housing region 822 defined by barrier rib member 820 of second battery housing tray 800 may be disposed so as to span two battery housing regions 722 defined by barrier rib member 720 of first battery housing tray 700. Any disposition is possible as long as one battery housing region 722 of barrier rib member 720 of first battery housing tray 700 is not overlapped to one battery housing region 822 of barrier rib member 820 of second battery housing tray 800 on one-to-one.

Hereinafter, the first to fifth exemplary embodiments of the present invention are specifically described with reference to examples. Note here that the present invention is not necessarily limited to the following the examples, and modifications can be made by changing materials to be used and the like within the scopes of the summary of the present invention.

### Example 1

Firstly, cylindrical batteries each having a height of 65 mm, an outer diameter of 18 mm, and a battery capacity of 2600 mAh are used. A three-row and three-column battery housing tray including a barrier rib member with a height of 32.6 mm (a height of more than 50% of the height of the battery) and an outer peripheral frame with a height of 67 mm is prepared. Nine batteries described above are housed in the battery housing tray. This is designated as sample 1.

### Example 2

Example 2 is carried out the same as Example 1 except that the height of the barrier rib member is 39 mm (a height of 60% of the height of the battery). This is designated as sample 2.

### Example 3

Example 3 is carried out the same as Example 1 except that the height of the barrier rib member is 52 mm (a height of 80% of the height of the battery). This is designated as sample 3.

### Example 4

Example 4 is carried out the same as Example 1 except that the height of the barrier rib member is 65 mm (a height of 100% of the height of the battery). This is designated as sample 4.

### Comparative Example 1

Comparative Example 1 is carried out the same as Example 1 except that the height of the barrier rib member is 26 mm (a height of 40% of the height of the battery). This is designated as sample C1.

The battery housing trays produced as mentioned above are evaluated as follows while housing a plurality of batteries.

Firstly, a battery from which safety mechanisms other than a vent mechanism are removed is produced. Nine of such batteries are housed and disposed in a three-row and three-column battery housing tray. Next, assuming that trouble in charging equipment occurs in only a battery in the center part, charging is carried out until the voltage of the battery in the center part becomes 5V to make it to eject gas. The gas is ignited to produce a flame.

At this time, thermocouples are respectively attached to the surrounding batteries at the opposite side of the surface facing the battery in the center part, and the increased temperature is measured. Furthermore, after the test is finished, each battery is decomposed, and a short-circuit state in an electrode group is observed. Furthermore, an opening state of the vent mechanism provided in each battery is observed.

Then, the influence of ignition of the battery in the center part on the surrounding batteries is evaluated with respect to the maximum increased temperature, the number of short-circuited batteries, the number of batteries whose vent mechanism is opened, and presence or absence of ignition or explosion.

Hereinafter, parameters and evaluation results of samples 1 to 4 and sample C1 are shown in Table 1.

TABLE 1

| | Parameters | | | Evaluation results | | | |
|---|---|---|---|---|---|---|---|
| | Height of | | | Maximum increased | Number of short- | | |
| | outer | Height of | Ratio of barrier | temperature of | circuited | Number of batteries | Ignition/explosion |
| | peripheral | barrier | rib height to | surrounding | batteries | whose vent mechanism | of surrounding |
| | frame (mm) | rib (mm) | battery height (%) | batteries (° C.) | (battery) | is opened (battery) | batteries |
| Sample 1 | 67 | 32.6 | >50 | 130 | 2 | 0 | N |
| Sample 2 | 67 | 39 | 60 | 110 | 1 | 0 | N |
| Sample 3 | 67 | 52 | 80 | 90 | 0 | 0 | N |
| Sample 4 | 67 | 65 | 100 | 80 | 0 | 0 | N |
| Sample C1 | 67 | 26 | 40 | 360 | 8 | 5 | P |

N: not present, P: present

As shown in Table 1, comparison among samples 1 to 4 and sample C1 is carried out. In battery housing trays partitioned by barrier rib member whose height is more than 50% of the height of the battery, opening of a vent mechanism, which may cause ignition or explosion in the surrounding batteries, is not observed. However, as sample C1, in a battery housing tray having a barrier rib member whose height is about 40% of the height of the battery, opening of a vent mechanism, which may cause an induced explosion or ignition in the surrounding batteries by ignition or explosion of the battery in the center part, is observed in five batteries out of eight batteries. In some batteries, ignition or explosion occurs. This is thought to be because by providing a barrier rib member having a predetermined height, opening of a vent mechanism, which may cause an induced explosion or ignition in the surrounding batteries, does not occur, and therefore ejection of an electrolytic solution can be efficiently prevented.

Furthermore, as shown in Table 1, comparison among sample 1, sample 2 and sample C1 is carried out. In the surrounding batteries, a battery with a short circuit is observed because a separator contracts due to temperature rise in an electrode group in the battery. In particular, in sample C1, all of the surrounding batteries are short-circuited. On the other hand, in the batteries of samples 1 and 2, a short circuit in an electrode group occurs in a part of the surrounding batteries. This is thought to be because opening of the vent mechanism does not occur but a heat insulation effect of suppressing heat of ignited battery is not sufficient in a barrier rib member having a height of about 60% of the battery height.

Furthermore, as shown in Table 1, in samples 3 and 4, even if ignition or explosion occurs in a battery in the center part, temperature rise is small and a short circuit in an electrode group or opening of a vent mechanism is not observed. That is to say, it is shown that when the height of the barrier rib member is made to be 80% or more of the battery height, even a fault occurs in some batteries, the influence of the fault on the surrounding batteries can be considerably suppressed.

### Sixth Exemplary Embodiment

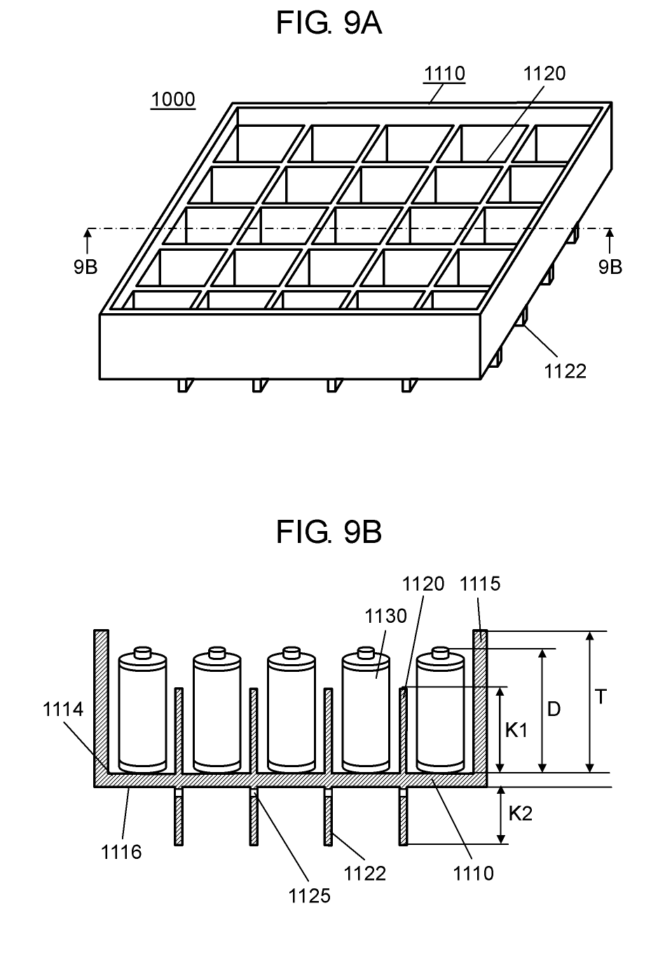

Hereinafter, a battery housing tray in accordance with a sixth exemplary embodiment of the present invention is described with reference to FIGS. 9A and 9B. This exemplary embodiment also describes an example in which cylindrical batteries that are the same as in FIG. 1 are housed.

FIG. 9A is a perspective view of a battery housing tray in accordance with a sixth exemplary embodiment of the present invention. FIG. 9B is a sectional view taken along line 9B-9B of FIG. 9A. For easy understanding, FIG. 9B shows a state in which cylindrical batteries shown in a perspective view are housed.

This exemplary embodiment is different from the first exemplary embodiment in the following points. A housing member includes a barrier rib member on an inner surface of a bottom part of the housing member, which is defined as a first barrier rib member, and further includes a second barrier rib member on an outer surface of the bottom part of the housing member in a position corresponding to the first barrier rib member. An air hole is provided in the second barrier rib member in a direction along the outer surface of the housing member. The sum of the height of the first barrier rib member and the height of the second barrier rib member is not less than the height of the battery. Other configurations are the same as those in the first exemplary embodiment.

As shown in FIG. 9A, battery housing tray 1000 has a configuration in which first barrier rib member 1120 and second barrier rib member 1122 are integrated with housing member 1110. First barrier rib member 1120 is made of an insulating resin material such as polypropylene resin and is provided on inner surface 1114 of the bottom part of housing member 1110; and second barrier rib member 1122 is made of an insulating resin material such as polypropylene resin and is provided on outer surface 1116 of the bottom part of housing member 1110.

Furthermore, as shown in FIG. 9B, second barrier rib member 1122 has air hole 1125 in a direction along outer surface 1116 of housing member 1110. Air hole 1125 has a function of exhausting a flame produced by ignition of gas accompanying ejected gas or explosion by an opening of a vent mechanism of a faulty battery when a plurality of battery housing trays are stacked, which is described in detail in the below-mentioned exemplary embodiment. First barrier rib member 1120 and second barrier rib member 1122 are provided facing each other with housing member 1110 sandwiched therebetween. Furthermore, a sum of height K1 of first barrier rib member 1120 and height K2 of second barrier rib member 1122 is not less than height D (a length between a positive electrode cap and a bottom surface of a battery case) of battery 1130 to be housed. At this time, when battery housing tray 1000 is used singly, it is preferable that height K1 of first barrier rib member 1120 is more than 50% of the height of battery 1130. For example, when the height of battery 1130 is 65 mm, the height of first barrier rib member 1120 is more than 32.5 mm.

As shown in FIG. 9B, this exemplary embodiment describes an example in which outer peripheral frame 1115 whose height is higher than height K1 of first barrier rib member 1120 is provided on the outer periphery of inner surface 1114 of the bottom part of housing member 1110. However, the configuration is not necessarily limited to this example. For example, height T of outer peripheral frame 1115 may be the same as height K of first barrier rib member 1120. In this case, it is preferable that an outer peripheral frame (not shown) whose height is the same as height K2 of second barrier rib member 1122 is provided on the outer periphery of outer surface 1116 of the bottom part of housing member 1110.

With the above-mentioned configuration, as shown in FIG. 9B, when a battery housing tray is used singly, a plurality of batteries 1130 are housed in battery housing tray 1000 formed of first barrier rib member 1120 whose height is more than 50% of the height of each battery 1130 and outer peripheral frame 1115 whose height exceeds the height of each battery 1130.

Note here that the present invention is based on the findings that when the height of first barrier rib member 1120 is not more than 50% of the height of battery 1130, due to ignition or explosion of a faulty battery, fire spreads to the batteries in the surroundings. Furthermore, with a configuration in which the height of outer peripheral frame 1115 of housing member 1110 is made to exceed the height of the battery, when a plurality of battery housing trays are stacked, energy of ignition or explosion of the battery is released to space formed by bringing first barrier rib member 1120 into contact with second barrier rib member 1122, it is possible to disperse the accumulated heat via air hole 1125 and to prevent the ignition or smoking of the surrounding batteries.

Furthermore, when a battery housing tray is used singly, in particular, it is preferable that height K1 of first barrier rib member 1120 is not less than 80% of height D of battery 1130. This is preferable because that a heat insulation effect by the barrier rib member can be increased.

Herein, the above-mentioned exemplary embodiment describes an example in which the materials of the housing member, the first barrier rib member and the second barrier rib member are polypropylene resin, but the material is not necessarily limited to this example. For example, phenol resin, UNILATE, glass epoxy resin, ceramic, and foaming resin may be used. At this time, it is preferable that the above-mentioned resin contains filler such as carbon fiber and glass fiber. The filler to be contained can prevent the strength of the housing member and the first and second barrier rib members from deteriorating and can maintain the shapes thereof at high temperatures at the time of heat generation or ignition of a faulty battery. Otherwise, when the shapes cannot be maintained, the faulty battery tends to fall toward the surrounding batteries. Thus, it is possible to reduce the influence of ignition and heat generation on the surrounding batteries and reduce the possibility of spread of fire. Furthermore, heat absorbing agent such as magnesium hydroxide (Mg(OH)₂) may be added in the above-mentioned resin. Thus, by transferring heat to the first and second barrier rib members in the surroundings, it is possible to suppress temperature rise in the battier rib member(s) around a faulty battery. Furthermore, by suppressing the temperature rise, it is possible to enhance the effect of preventing the strength of the first and second barrier rib members and the like from deteriorating and maintaining the shape.

Furthermore, the housing member and the first and second barrier rib members may have a configuration in which metal materials such as copper (Cu), aluminum (Al) and iron (Fe) are coated with the above-mentioned insulating resin. Thus, high heat transfer property can be achieved and the mechanical strength can be enhanced. When a short circuit due to contact with battery does not occur, the housing member and the barrier rib members may be formed of only metal materials. Furthermore, the metal material may have a mesh structure or a structure having a plurality of through holes. Thus, while the heat transfer property or mechanical strength can be maintained, the weight of the housing member and the first and second barrier rib members can be reduced.

According to this exemplary embodiment, a flame occurring at the time of ignition or explosion of gas ejected from a vent hole of a faulty battery can be dispersed into space above the first barrier rib member, thus preventing spread of fire to the surrounding batteries or abnormal overheating. Furthermore, by setting the height of the first barrier rib member to a predetermined height, heating of an electrode group inside a battery case of the battery can be considerably suppressed, spread of fire, and the like, can be prevented.

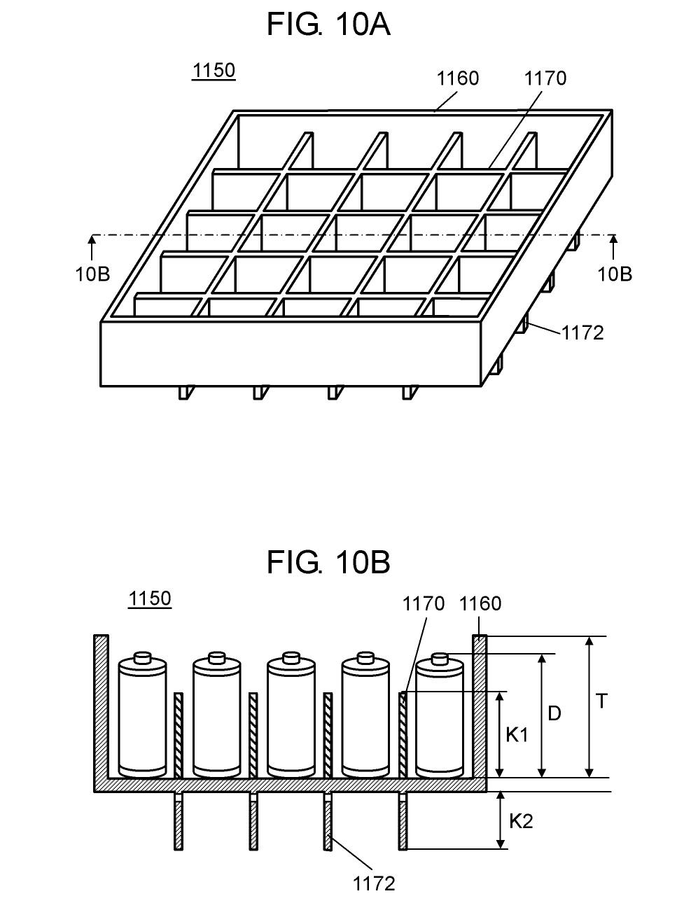

Note here that the above-mentioned exemplary embodiment describes an example of a structure in which the housing member, and the first and second barrier rib members are integrated with each other, but the structure is not particularly limited to this example. For example, as shown in FIG. 10A that is a perspective view showing another example of a battery housing tray in accordance with the sixth exemplary embodiment of the present invention and FIG. 10B that is a sectional view taken along line 10B-10B of FIG. 10A, battery housing tray 1150 may have a configuration in which housing member 1160 and at least first barrier rib member 1170 and second barrier rib member 1172 can be separated from each other. Thus, by only preparing the first barrier rib member and the second barrier rib member corresponding to the shapes of batteries, various types of batteries can be housed in the same housing member. As a result, it is possible to achieve a battery housing tray with high versatility, which is capable of stacking batteries having different shapes in multiple stages.

### Seventh Exemplary Embodiment

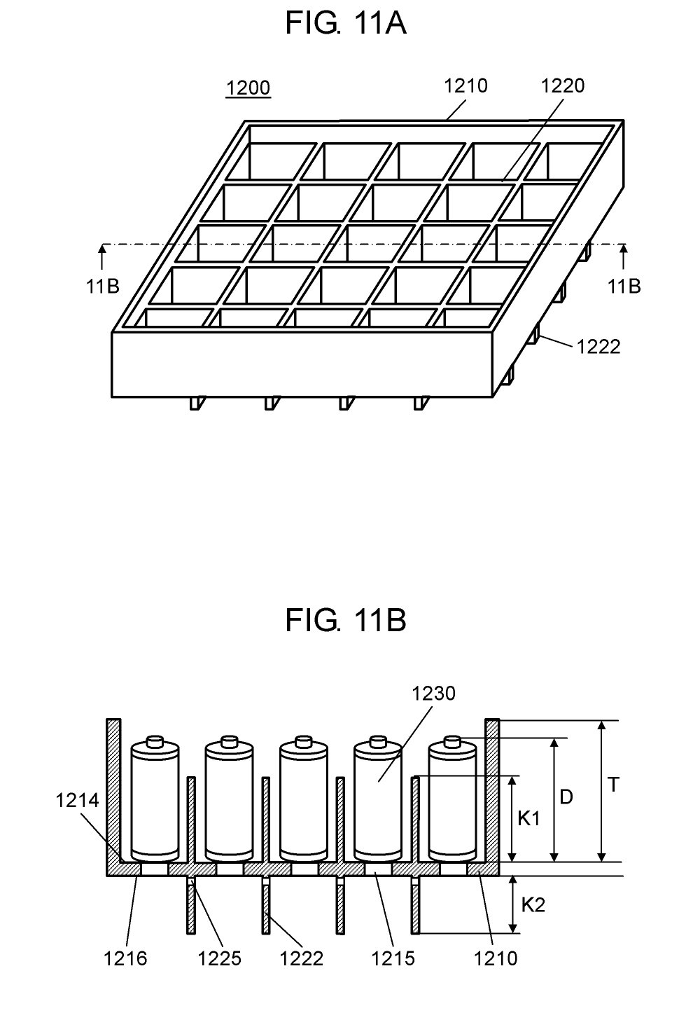

FIG. 11A is a perspective view showing a battery housing tray in accordance with a seventh exemplary embodiment of the present invention. FIG. 11B is a sectional view taken along line 11B-11B of FIG. 11A. This exemplary embodiment also describes an example in which cylindrical batteries that are the same as those in FIG. 1 are housed.

This exemplary embodiment is different from the sixth exemplary embodiment in that a through hole penetrating from an inner surface to an outer surface of a bottom part of a housing member is provided. Note here that other configurations are the same as those in the sixth exemplary embodiment.

As shown in FIG. 11A, similar to the sixth exemplary embodiment, battery housing tray 1200 includes first barrier rib member 1220 provided on inner surface 1214 of the bottom part of housing member 1210 and made of an insulating resin material such as polypropylene resin, and second barrier rib member 1222 made of an insulating resin material such as polypropylene resin and provided on outer surface 1216 of the bottom part of housing member 1210, which are integrated into housing member 1210.

Furthermore, as shown in FIG. 11B, second barrier rib member 1222 includes air holes 1225 in a direction along outer surface 1216 of the bottom part of housing member 1210. First barrier rib member 1220 and second barrier rib member 1222 are provided facing each other on the same position with the bottom part of housing member 1210 sandwiched therebetween. Furthermore, a sum of height K1 of first barrier rib member 1220 and K2 of second barrier rib member 1222 is not less than height D (a length between a positive electrode cap and a bottom surface of a battery case) of batteries 1230 to be housed.

As shown in FIG. 11B, in housing member 1210, in a battery housing region surrounded by first barrier rib member 1220 and second barrier rib member 1222, through hole 1215 which is smaller than the outer diameter of battery 1230 and which penetrates from inner surface 1214 to outer surface 1216 of the bottom part of housing member 1210 are provided.

According to this exemplary embodiment, battery housing tray 1200 in a state of housing batteries 1230 is disposed on a charging and discharging tester, in which the plus of a positive electrode cap of the battery and the minus on the bottom part of the battery case are connected to the tester via through hole 1215 in housing member 1210. Thus, the battery can be evaluated. During a charging and discharging test, even if ignition or explosion of a faulty battery, furthermore, explosion or ignition caused by an abnormal voltage or an electric current due to a fault of the tester may occur, it is possible to prevent the fire from spreading to the surrounding batteries by first barrier rib member 1220 similar to the sixth exemplary embodiment.

At this time, it is further preferable that through hole 1215 is smaller than the diameter of the top portion of the positive electrode cap of battery 1230. This is preferable because a flame and the like can be prevented from directly parching a battery disposed immediately (directly) above when a flame occurs at the time of structuring an assembled battery housing tray in which battery housing trays are stacked, and the flame is ejected in the oblique direction from the vent hole provided on the side surface of the positive electrode cap of the battery, which is described in detail in the following exemplary embodiment.

### Eighth Exemplary Embodiment

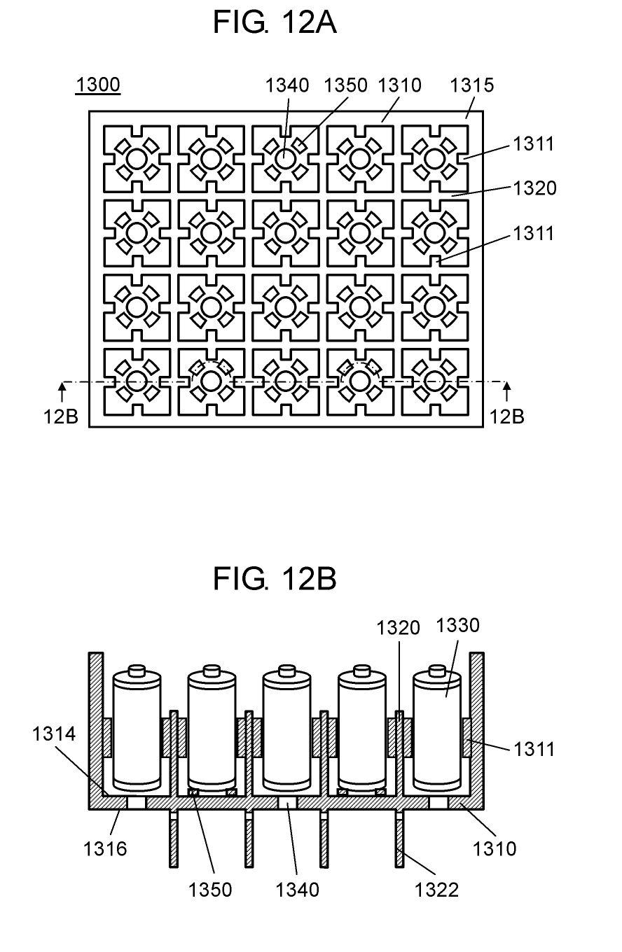

FIG. 12A is a plan view of a battery housing tray seen from the upper part in accordance with an eighth exemplary embodiment of the present invention. FIG. 12B is a sectional view taken along line 12B-12B of FIG. 12A. This exemplary embodiment also describes an example in which cylindrical batteries that are the same as those in FIG. 1 are housed.

As shown in FIG. 12A, battery housing tray 1300 includes first barrier rib member 1320 provided on inner surface 1314 of the bottom part of housing member 1310 and made of an insulating resin material such as polypropylene resin, and second barrier rib member 1322 made of an insulating resin material such as polypropylene resin and provided on outer surface 1316 of the bottom part of housing member 1310, which are integrated with housing member 1310. Furthermore, rib portions 1311 are provided in the inner side of housing member 1310 and the inner side of at least first barrier rib member 1320. Furthermore, in housing member 1310, in a region surrounded by first barrier rib member 1320 and second barrier rib member 1322, through hole 1340 smaller than the outer diameter of battery 1330 and rib portion 1350 partially holding the bottom part of battery 1330 is provided on the inner surface 1314 of a bottom part of housing member 1310.

As shown in FIG. 12B, when predetermined battery 1330 is housed, housing member 1310 has outer peripheral frame 1315 having height T exceeding height D (a length between a positive electrode cap and a bottom surface of a battery case) of the battery. Furthermore, first barrier rib member 1320 individually houses a plurality of predetermined batteries 1330 and has a height that is more than 50% of the height of battery 1330 from a contact surface between rib portion 1350 on inner surface 1314 of the bottom part of housing member 1310 and battery 1330. For example, when the height of a rib portion is 1 mm and the height of a battery is 65 mm, the height of first barrier rib member 1320 is more than 33.5 mm.

The configurations and materials of the above-mentioned housing members, the first and second barrier rib members, the rib portions, and the like, are the same as those in the sixth exemplary embodiment, and the description therefor is omitted herein.

According to this exemplary embodiment, similar to the sixth exemplary embodiment, a flame occurring at the time of ignition or explosion of gas ejected from a vent hole of a faulty battery can be dispersed into space above the first barrier rib member, thus preventing spread of fire to the surrounding batteries or preventing abnormal overheating.

Furthermore, according to this exemplary embodiment, with the rib portions provided on the housing member and the first barrier rib member, positioning of batteries to be housed can be carried out easily. Furthermore, the distance between the neighboring batteries can be kept uniform. Thus, the influence of heat generation or ignition of a faulty battery on the neighboring batteries can be made to be uniform. Therefore, the influence of heat generation and the like can be further suppressed as compared with the case in which rib portions are not provided.

Furthermore, according to the exemplary embodiment of the present invention, with the rib portions provided on the housing member and the first barrier rib member, a circulation passage of air and the like is formed, so that a temperature around the batteries can be made to be uniform during, for example, an aging process.

The above-mentioned exemplary embodiment describes an example in which through holes are provided in the bottom part of the housing member, but through holes may not be provided when a charging and discharging test is not carried out. Furthermore, the exemplary embodiment describes an example in which rib portions are provided on the inner surface of the bottom part of the housing member, but they are not particularly necessary when only positioning of the battery is intended.

### Ninth Exemplary Embodiment

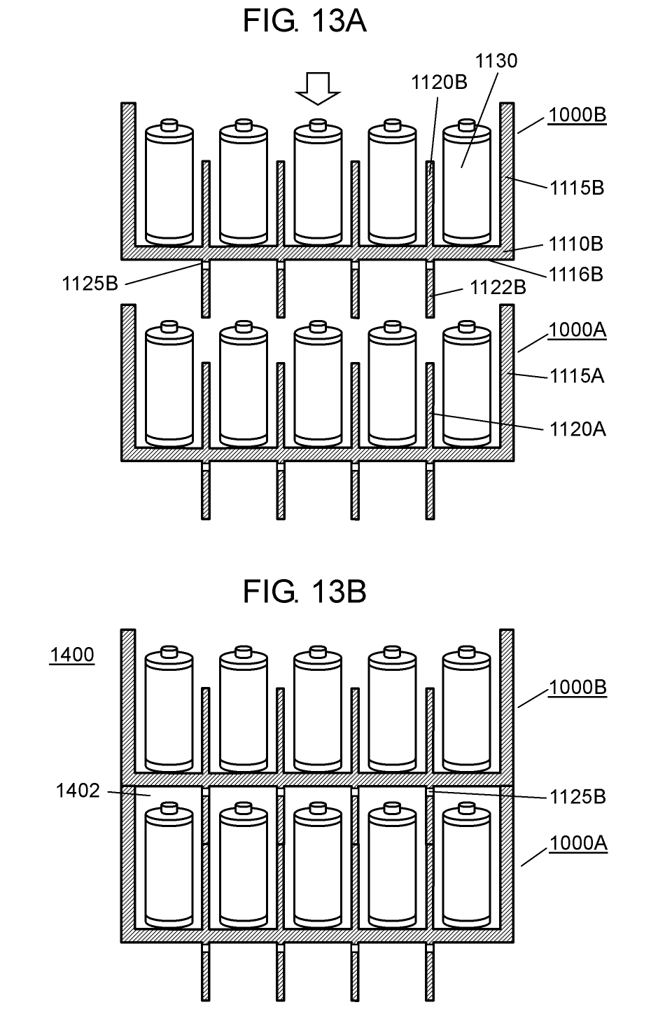

FIGS. 13A and 13B are sectional views to illustrate an assembled battery housing tray in accordance with a ninth exemplary embodiment of the present invention. FIG. 13A shows a state before battery housing trays are stacked, and FIG. 13B shows a state after battery housing trays are stacked. This exemplary embodiment also describes an example in which cylindrical batteries that are the same as those in FIG. 1 are housed.

As shown in FIGS. 13A and 13B, assembled battery housing tray 1400 in accordance with the ninth exemplary embodiment of the present invention has a configuration in which battery housing trays 1000A and 1000B described in the sixth exemplary embodiment are stacked in, for example, two stages. Since the configurations of battery housing trays 1000A and 1000B are the same as those of the battery housing tray in the sixth exemplary embodiment, the description therefor is omitted.

That is to say, as shown in FIG. 13B, first barrier rib member 1120A of battery housing tray 1000A and second barrier rib member 1122B of battery housing tray 1000B are brought into contact with each other and stacked. At this time, for example, first barrier rib member 1120A of battery housing tray 1000A and second barrier rib member 1122B of battery housing tray 1000B are brought into contact with each other, so that space 1402 is formed. Then, space 1402 is shared by the entire assembled battery housing tray via air hole 1125B of second barrier rib member 1122B. This is because a sum of the height of first barrier rib member 1120A and the height second barrier rib member 1122B is higher than the height of battery 1130 to be housed.

Note here that FIG. 13B shows that outer peripheral frame 1115A of battery housing tray 1000A and outer surface 1116B of the bottom part of housing member 1110B of battery housing tray 1000B are similarly brought into contact with each other, but they are not necessarily brought into contact with each other and a gap may be formed therebetween.

Consequently, by dispersing energy generated by ignition or explosion of a faulty battery to space 1402 shared via air hole 1125B, abnormal overheating or concentration of a flame on the surrounding batteries can be reduced and thus an induced explosion or spread of fire can be prevented. In battery housing tray 1000B, an influence on the surrounding battery can be reduced because an upper part of battery 1130 is opened.

According to this exemplary embodiment, it is possible to achieve an assembled battery housing tray with safety and high reliability in which the influence of heat generation or ignition of a faulty battery can be prevented even when a plurality of battery housing trays are stacked.

In the above mention, a configuration in which the battery housing trays of the sixth exemplary embodiment are stacked is described, but the configuration is not necessarily limited to this example. The battery housing trays of the seventh or eighth exemplary embodiment may be stacked. In such cases, the same effect can be obtained.

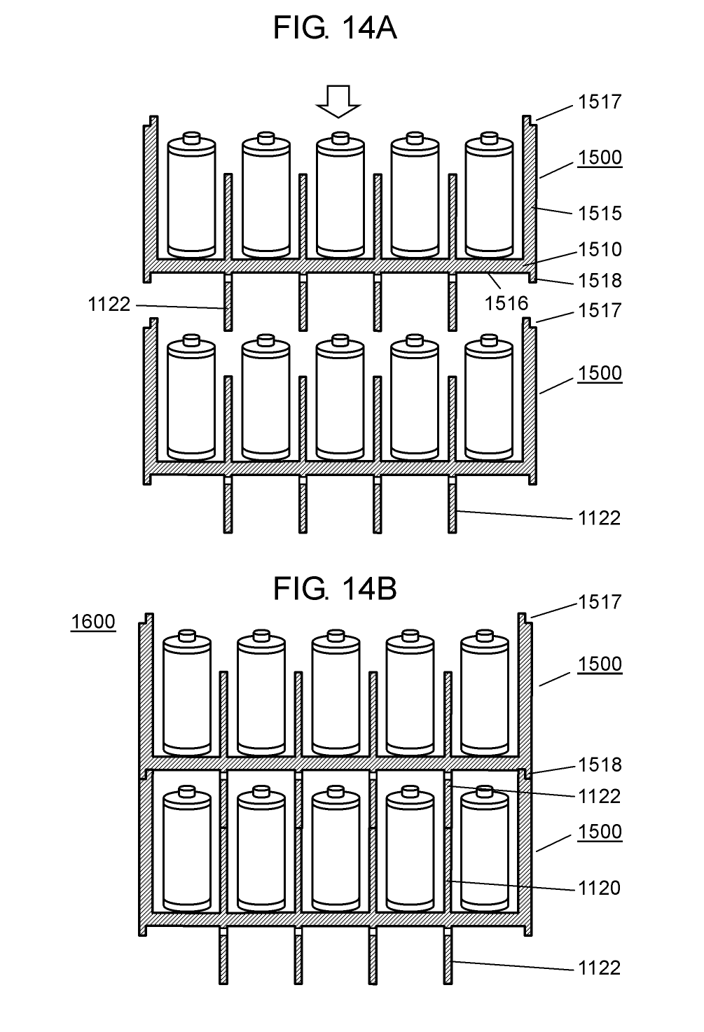

Hereinafter, another example 1 of the assembled battery housing tray in accordance with the ninth exemplary embodiment of the present invention is described with reference to FIGS. 14A and 14B.

FIGS. 14A and 14B are sectional views to illustrate another example 1 of an assembled battery housing tray in accordance with the ninth exemplary embodiment of the present invention. FIG. 14A is a sectional view showing a state before battery housing trays are stacked, and FIG. 14B is a sectional view showing a state after battery housing trays are stacked.

That is to say, as shown in FIG. 14A, battery housing tray 1500 includes first concave portion 1517 at the end surface of outer peripheral frame 1515 of housing member 1510, and second convex portion 1518 to be fitted with first concave portion 1517 is provided on outer surface 1516 of the bottom part of barrier rib member 1510. Then, for example, first concave portion 1517 of battery housing tray 1500 on the lower stage is allowed to be fitted with second convex portion 1518 of battery housing tray 1500 on the upper stage, and first barrier rib member 1120 on the lower stage and second barrier rib member 1122 on the upper stage are brought into contact with each other. Thus, assembled battery housing tray 1600 is formed.

Thus, it is possible to achieve an assembled battery housing tray capable of preventing battery housing trays to be stacked from being displaced and of improving stability at the time of stacking.

In the above mention, an example in which a first concave portion is provided on an outer peripheral frame of a housing member and a second convex portion is provided on the bottom part side. However, the configuration is not necessarily limited to this example. For example, a configuration in which the first convex portion is provided on the outer peripheral frame of the housing member and the second concave portion is provided on the bottom part may be employed. With such a configuration, the same effect can be obtained.

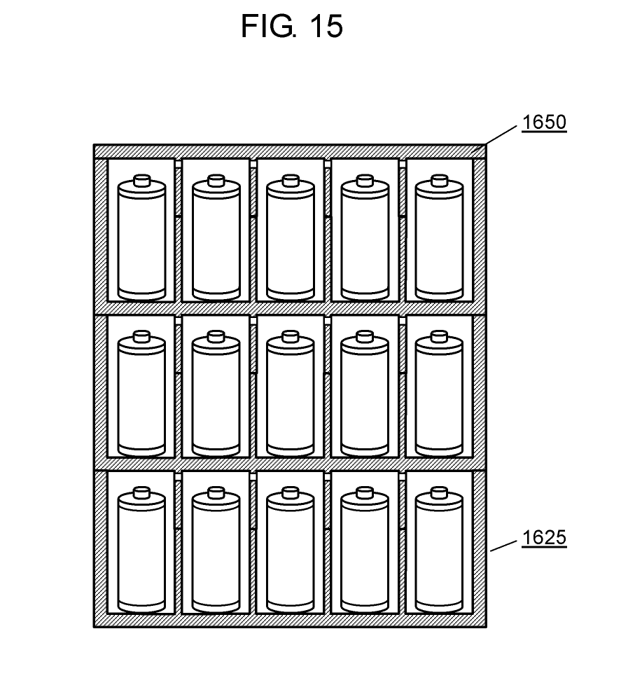

The above-mentioned exemplary embodiment describes an example in which a second convex portion and a second barrier rib member are provided on battery housing tray on the bottom stage. However, as shown in another example 2 of the assembled battery housing tray in FIG. 15, as battery housing tray 1625, the second convex portion and a second barrier rib member on the bottom stage may be removed. Furthermore, the above-mentioned exemplary embodiment describes a state in which an upper part of the battery housing tray on the top stage is opened, but the configuration is not necessarily limited to this example. For example, as shown in FIG. 15, a configuration in which lid 1650 is formed of the housing member from which an outer peripheral frame and a first barrier rib member are removed and which includes a second barrier rib member, and the battery housing tray on the top stage is be lidded by lid 1650 may be employed. Thus, even if ignition or explosion occurs in a faulty battery in the battery housing tray on the top stage, scattering thereof can be securely prevented by lid 1650.

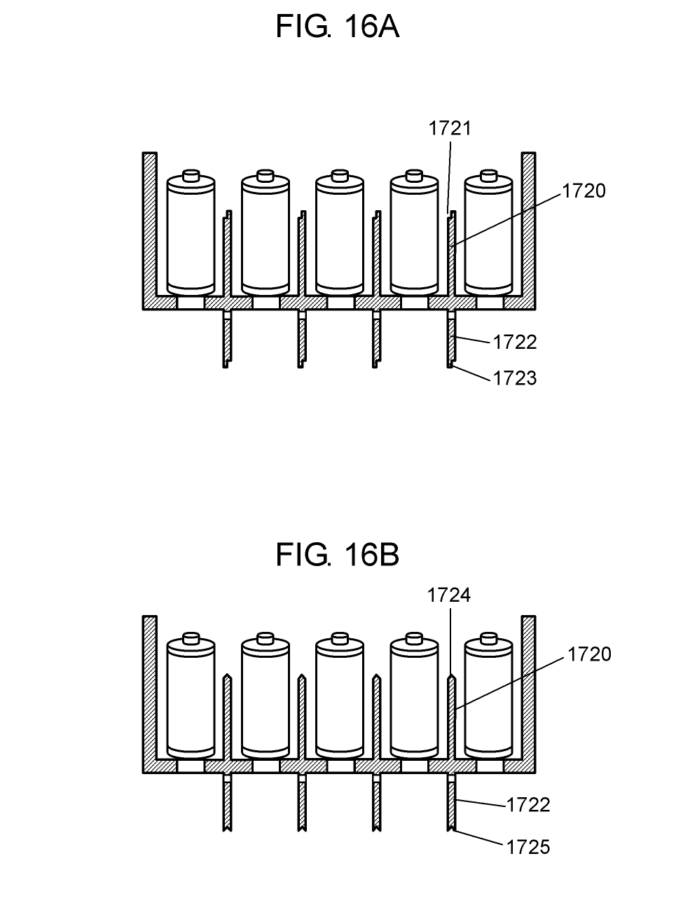

Furthermore, the above-mentioned exemplary embodiment describes an example in which a first concave portion is provided on the outer peripheral frame of the housing member is provided, and a second convex portion is provided on the outer surface of the bottom part of the housing member. However, the configuration is not necessarily limited to this example. For example, as shown in another example 1 of FIG. 16A, first concave portion 1721 is provided on first barrier rib member 1720 and second convex portion 1723 is provided on second barrier rib member 1722, and they may be fitted with each other to be stacked. Furthermore, as shown in another example 2 of FIG. 16B, for example, conical or pyramid-shaped first convex portion 1724 is provided on an end portion of first barrier rib member 1720, and conical or pyramid-shaped second concave portion 1725 to be fitted with first convex portion 1724 is provided on the end portion of second barrier rib member 1722, and they may be fitted with each other to be stacked.

Similar to the above, these configurations make it easy to stack battery housing trays and to securely prevent side slip and the like. Furthermore, it is possible to improve the airtightness of space formed by the first barrier rib member and the second barrier rib member, and to effectively prevent a flame from diffusing between the contact surfaces of the first barrier rib member and the second barrier rib member.

### Tenth Exemplary Embodiment

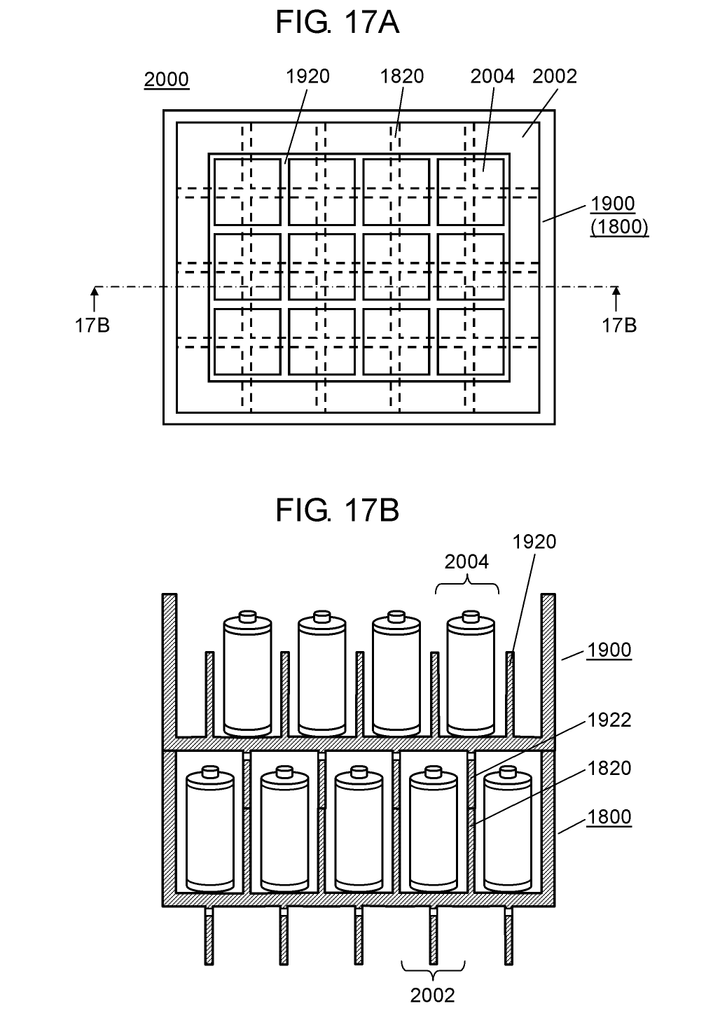

FIG. 17A is a transparent plan view of an assembled battery housing tray seen from the upper part in accordance with a tenth exemplary embodiment of the present invention. FIG. 17B is a sectional view taken along line 17B-17B of FIG. 17A. For easy understanding, FIG. 17B shows a state in which cylindrical batteries shown in a perspective view are housed.

As shown in FIG. 17B, this exemplary embodiment is different from the ninth exemplary embodiment in that batteries in a battery housing tray on the lower stage and batteries in a battery housing tray on the upper stage are shifted from each other in the stacked direction so that they are not immediately (directly) overlapped to each other. Hereinafter, an example in which the battery housing trays stacked in two stages is described, but the configuration is not necessarily limited to this example.

That is to say, as shown in FIG. 17B, on first battery housing tray 1800 provided with at least first barrier rib member 1820, second battery housing tray 1900 provided with first barrier rib member 1920 and second barrier rib member 1922 is stacked, thus forming assembled battery housing tray 2000. At this time, as shown in FIG. 17A, battery housing region 2002 surrounded by first barrier rib member 1820 of first battery housing tray 1800 and second barrier rib member 1922 of second battery housing tray 1900 (broken line in the drawing) and battery housing region 2004 surrounded by barrier rib member 1920 of first battery housing tray 1800 are disposed such that they are shifted from each other.

According to this exemplary embodiment, at the time of stacking one battery to be stacked is not disposed immediately above another battery. Therefore, the distance between the stacked batteries is increased, and the influence of ignition or explosion caused by a faulty battery can be further reduced.

In this exemplary embodiment, battery housing region 2004 surrounded by first barrier rib member 1920 of second battery housing tray 1900 is disposed so as to span four battery housing regions 2002 of first barrier rib member 1820 of first housing tray 1800. However, the configuration is not necessarily limited to this example. For example, battery housing region 2004 of first barrier rib member 1920 of second battery housing tray 1900 may be disposed so as to span two battery housing regions 2002 of first barrier rib member 1820 of first battery housing tray 1800. Any disposition is possible as long as battery housing region 2002 of first battery housing tray 1800 and battery housing region 2004 of second battery housing tray 1900 are not overlapped to each other (do not coincide with each other).

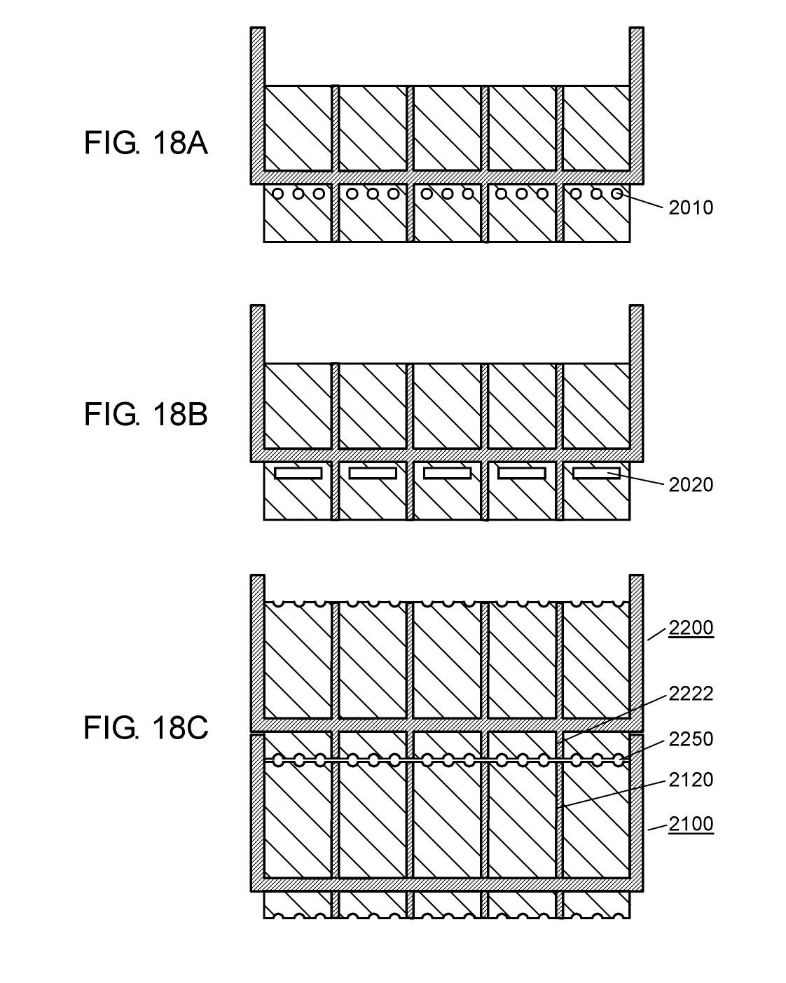

Note here that the shapes of the air hole of the second barrier rib member described in the assembled battery housing tray in the above-mentioned eighth or ninth exemplary embodiment include any shapes such as circular-shaped air hole 2010 or rectangular-shaped air hole 2020 as shown in FIGS. 18A and 18B. At this time, it is preferable that the air hole is disposed in the vicinity of a vent hole of the housed battery.

Furthermore, when the height of first barrier rib member 2120 of battery housing tray 2100 on the lower stage of the assembled battery housing tray is not less than 80% of the height of the battery, as shown in FIG. 18C, for example, a semicircular air hole may be formed on end portion of the contact surface 2250 side between barrier rib member 2120 of battery housing tray 2100 and second barrier rib member 2222 of battery housing tray 2200.

Hereinafter, the sixth to tenth exemplary embodiments of the present invention are specifically described with reference to examples. Note here that the present invention is not necessarily limited to the following examples, and modifications can be made by changing materials to be used and the like within the scopes of the present invention.

### Example 5

Firstly, cylindrical batteries each having a height of 65 mm, an outer diameter of 18 mm, and a battery capacity of 2600 mAh are used. A three-row and three-column battery housing tray including a first barrier rib member having a height of 32.6 mm (a height exceeding 50% of a height of the battery) and a second barrier rib member provided with an air hole and having a height of 34.4 mm is produced. The thus obtained battery housing trays are stacked to form an assembled battery housing tray, and nine batteries described above are housed in a three-row and three-column battery housing tray on at least the lower stage. This is designated as sample 5.

### Example 6

Example 6 is carried out the same as Example 5 except that the height of the first barrier rib member is 39 mm (a height of 60% of the height of the battery) and the height of the second barrier rib member is 28 mm. This is designated as sample 6.

### Example 7

Example 7 is carried out the same as Example 5 except that the height of the first barrier rib member is 52 mm (a height of 80% of the height of the battery) and the second barrier rib member is 15 mm. This is designated as sample 7.

### Example 8

Example 8 is carried out the same as Example 5 except that the height of the barrier rib member is 65 mm (a height of 100% of the height of the battery), the height of the second barrier rib member is 2 mm, and air holes are provided in the vicinity of shorter side of the first barrier rib (at height of 55 mm). This is designated as sample 8.

### Example 9

Example 9 is carried out the same as Example 5 except that the height of the first barrier rib member is 26 mm (a height of 40% of the height of the battery), the height of the second barrier rib member is 36 mm, and the battery housing trays are stacked via the outer peripheral frame with a height of 67 mm, and a gap (5 mm) is provided between the first barrier rib member and the second barrier rib member. This is designated as sample 9.

### Example 10

Example 10 is carried out the same as Example 5 except that the height of the barrier rib member is 32.6 mm (a height of more than 50% of the height of the battery) and the height of the second barrier rib member is 0 mm. This is designated as sample 10.

### Example 11

Example 11 is carried out the same as Example 5 except that the height of the barrier rib member is 52 mm (a height of 80% of the height of the battery) and the height of the second barrier rib member is 0 mm. This is designated as sample 11.

### Comparative Example 2

Comparative Example 2 is carried out the same as Example 5 except that the height of the first barrier rib member is 26 mm (a height of 40% of the height of the battery), the height of the second barrier rib member is 0 mm, and the battery housing trays are stacked via the outer peripheral frame with a height of 67 mm, and a gap (41 mm) is provided between the first barrier rib member and the second barrier rib member. This is designated as sample C2.

The battery housing trays produced as mentioned above while housing a plurality of batteries are evaluated as follows.

Firstly, a battery from which safety mechanisms other than a vent mechanism are removed is produced. Nine of such batteries are housed and disposed in a three-row and three-column battery housing tray. Next, assuming that trouble in charging equipment occurs in only a battery in the center part, the battery in the center part is charged until the battery voltage becomes 5V to eject gas. The gas is ignited to produce a flame.

At this time, thermocouples are respectively attached to the surrounding batteries at the opposite side of the surface facing the battery in the center part, and the increased temperature is measured. Furthermore, after the test is finished, each battery is decomposed, and a short-circuit state of an electrode group is observed. Furthermore, an opening state of the vent mechanism provided in each battery is observed.

Then, the influence of ignition of the battery in the center part on the surrounding batteries is evaluated with respect to the maximum increased temperature, the number of short-circuited batteries, the number of batteries whose vent mechanism is opened, and presence or absence of ignition or explosion.

Hereinafter, parameters and evaluation results of samples 5 to 11 and sample C2 are shown in Table 2.

TABLE 2

| | Parameters | | | Evaluation results | | | |
|---|---|---|---|---|---|---|---|
| | Height of | Height of | Ratio of first | Maximum increased | Number of short- | | |
| | first | second | barrier rib | temperature of | circuited | Number of batteries | Ignition/explosion |
| | barrier | barrier | height to battery | surrounding | batteries | whose vent mechanism | of surrounding |
| | rib (mm) | rib (mm) | height (%) | batteries (° C.) | (battery) | is opened (battery) | batteries |
| Sample 5 | 32.6 | 33.4 | >50 | 70 | 0 | 0 | N |
| Sample 6 | 39 | 28 | 60 | 70 | 0 | 0 | N |
| Sample 7 | 52 | 15 | 80 | 70 | 0 | 0 | N |
| Sample 8 | 65 | 2 | 100 | 70 | 0 | 0 | N |
| Sample 9 | 26 | 36 | 40 | 80 | 0 | 0 | N |
| Sample 10 | 32.6 | 0 | >50 | 130 | 2 | 0 | N |
| Sample 11 | 52 | 0 | 80 | 90 | 0 | 0 | N |
| Sample C2 | 26 | 0 | 40 | 360 | 8 | 5 | P |

N: not present, P: present

As shown in Table 2, in samples 5 to 9, temperature rise, a short circuit in an electrode group, and opening of a vent mechanism do not occur in the surrounding batteries. This is thought to be because battery housing trays are stacked and batteries are housed in space surrounded by the first barrier rib member and the second barrier rib member, so that the influence of a fault can be considerably suppressed in each barrier rib member even if a fault occurs in a part of batteries.

Furthermore, as shown in Table 2, when comparison among sample 10, sample 11 and sample C2 is carried out, in the battery housing tray partitioned by the first barrier rib member whose height is more than 50% of the height of the battery, even in a case where a battery housing tray is used singly or used in a top stage, opening of a vent mechanism, which may cause ignition or explosion in the surrounding batteries, is not observed. In particular, as sample 7, it is shown that by setting the height of the first barrier rib member to be not less than 80% of the height of the battery, a short circuit in the electrode group in the surrounding batteries can be suppressed sufficiently.

However, as sample C2, in a battery housing tray having a first barrier rib member whose height is about 40% of the height of the battery, opening of a vent mechanism, which may cause an induced explosion or ignition in the surrounding batteries by ignition or explosion of the battery in the center part, is observed in five batteries out of eight batteries. In some batteries, ignition or explosion occurs. This is thought to be because by providing a first barrier rib member having a predetermined height, opening of a vent mechanism, which may cause an induced explosion or ignition in the surrounding batteries, does not occur, and therefore ejection of an electrolytic solution can be efficiently prevented.

From the above mention, it is shown that when batteries are housed in the battery housing trays that are stacked, an assembled battery housing tray capable of securing sufficient safety can be obtained when the height of the first barrier rib member in the battery housing tray in at least the top stage of the stacked trays is made to be the height exceeding 50% of the height of the battery. In the battery housing trays other than that in the top stage, batteries can be housed inside of the first barrier rib member and the second barrier rib member. Therefore, it is shown that when an air hole is provided or formed, the ratio of the height of each barrier rib member to the height of the battery is not particularly considered.

Furthermore, as shown in Table 2, when comparison between samples 5 to 8 and sample 9 is carried out, the temperature rise in the surrounding batteries is slightly larger in sample 9. This is thought to be because a gap portion, which is formed between the first barrier rib member with a height is about 40% of the height of the battery and the second barrier rib member, is used as an air hole, so that more heat is applied to the vicinity of the electrode group in the battery as compared with a battery housing tray having an air hole in the vicinity of an exhaust air valve of the battery. However, when the gap portion is about 5 mm, it is thought that safety is secured.

### INDUSTRIAL APPLICABILITY

The present invention is useful as a battery housing tray for housing a battery and the like, which requires high reliability and safety.

1. A battery housing tray for housing a plurality of batteries each having a vent mechanism, the battery housing tray comprising:
a housing member including an outer peripheral frame with a height exceeding a height of each of a plurality of batteries, and a bottom part; and
a barrier rib member configured to individually house the batteries in the housing member; and
an opening opposite the bottom part,
wherein a height of the barrier rib member is more than 50% of the height of each of the batteries and less than the height of the outer peripheral frame of the housing member, and
the batteries are housed in a manner that a vent mechanism side of each of the batteries faces the opening.

2. The battery housing tray according to claim 1,
wherein a through hole smaller than a shape of each of the batteries is provided in a position for housing each of the batteries in the barrier rib member on the bottom part of the housing member.

3. The battery housing tray according to claim 1,
wherein the housing member and the barrier rib member are provided separably.

4. The battery housing tray according to claim 1,
wherein the housing member and the barrier rib member have a structure in which a metal material is coated with insulating resin.

5. The battery housing tray according to claim 1,
wherein rib portions are provided on an inner surface side of the housing member and the barrier rib member.

6. The battery housing tray according to claim 1,
wherein a rib portion is provided on the bottom part of the housing member for housing each of the batteries in the barrier rib member.

7. The battery housing tray according to claim 1,
wherein a first concave portion or a first convex portion is provided on the outer peripheral frame of the housing member, when the first concave portion is provided, a second convex portion is provided on an outer surface of the bottom part of the housing member in a position corresponding to the first concave portion, and
when the first convex portion is provided, a second concave portion is provided on an outer surface of the bottom part of the housing member in a position corresponding to the first convex portion.

8. The battery housing tray according to claim 1,
wherein the barrier rib member provided on the housing member is defined as a first barrier rib member,
a second barrier rib member is further provided in a position corresponding to the first barrier rib member on an outer surface of the bottom part of the housing member, and
the second barrier rib member is provided with an air hole in a direction along a surface of an outer surface of the bottom part of the housing member, and a sum of the height of the first barrier rib member and a height of the second barrier rib member is not lower than the height of each of the batteries.

9. The battery housing tray according to claim 8,
wherein a through hole smaller than a shape of each of the batteries is formed in a position for housing each of the batteries in the first barrier rib member on the housing member.

10. The battery housing tray according to claim 8,
wherein the first barrier rib member and the second barrier rib member are provided separably from the housing member.

11. The battery housing tray according to claim 8,
wherein the housing member, the first barrier rib member, and the second barrier rib member have a structure in which a metal material is coated with insulating resin.

12. The battery housing tray according to claim 8,
wherein rib portions are provided on an inner surface side of at least the housing member and the barrier rib member.

13. The battery housing tray according to claim 8,
wherein rib portions are provided on an inner surface of the bottom part of the housing member for housing each of the batteries in the first barrier rib member.

14. The battery housing tray according to claim 8,
wherein a first concave portion or a first convex portion is provided on the first barrier rib member,
when the first concave portion is provided, a second convex portion is provided on the second housing member in a position corresponding to the first concave portion, and
when the first convex portion is provided, a second concave portion is provided on the second barrier rib member in a position corresponding to the first convex portion.

15. An assembled battery housing tray comprising
a plurality of battery housing trays according to claim 1 in which the battery housing trays are stacked to each other.

16. The assembled battery housing tray according to claim 15,
wherein each of the battery housing trays includes a first battery housing tray having a barrier rib member in the housing member, and a second battery housing tray having a barrier rib member in the housing member, and,
when the first battery housing tray and the second battery housing tray are stacked to each other, a position of the barrier rib member of the first battery housing tray and a position of the barrier rib member of the second battery housing tray are shifted from each other in a stacking direction.

17. The assembled battery housing tray according to claim 15,
wherein the battery housing trays include a first battery housing tray having a first barrier rib member in the housing member and a second barrier rib member on an outer surface of the bottom part, and a second battery housing tray having a first barrier rib member in the housing member and a second barrier rib member on an outer surface of the bottom part,
when the first battery housing tray and the second battery housing tray are stacked on each other, positions of the first barrier rib member and the second barrier rib member of the first battery housing tray and positions of the first barrier rib member and the second barrier rib member of the second battery housing tray are shifted from each other in a stacking direction, and the second barrier rib member of the first battery housing tray and the first barrier rib member of the second battery are located in a corresponding position in a stacking direction.

18. The assembled battery housing tray according to claim 15,
wherein the battery housing trays include a first battery housing tray having a first barrier rib member in the housing member and a second barrier rib member on an outer surface of the bottom part, and a second battery housing tray having a first barrier rib member in the housing member, and
when the first battery housing tray and the second battery housing tray are stacked to each other, the second barrier rib member of the first battery housing tray and the first barrier rib member of the second battery are located in a corresponding position in a stacking direction.

19. The assembled battery housing tray according to claim 15 further comprising a lid stacked on an uppermost battery housing tray on the stacked battery housing trays,
wherein each of the battery housing trays has a barrier rib member in the housing member, the lid has a second barrier rib member in a position corresponding to the first barrier rib member of the uppermost battery housing tray when the lid is stacked on the uppermost battery housing tray.
